(19) United States
(12) Patent Application Publication
(10) Pub. No.: US 2003/0055541 A1
(43) Pub. Date: Mar. 20, 2003

(54) 911 Autopilot - preventing aircraft hijackings using inexpensive technology and procedures

(76) Inventor: Mark Ray Haley, Garland, TX (US)

Correspondence Address: Mark R. Haley, 1814 Creek Way Drive, Garland, TX, 75043, US

(21) Appl. No.: 10/234,769

(22) Filed: Sep. 4, 2002

Related U.S. Application Data
(60) Provisional application No. 60/322,442, filed on Sep. 17, 2001.
(60) Provisional application No. 60/322,470, filed on Sep. 17, 2001.

(51) Int. Cl. G06F 17/00

(52) U.S. Cl. 701/11; 340/945

(57) ABSTRACT

Mark R. Haley has procedures and technology, which would prevent hijacking of aircraft. This system would include a password protected autopilot system, which is automatically engaged if the pilot opens the cockpit door after takeoff or if the cockpit door is forcibly opened. The password-protected autopilot could only be overridden by the pilot (or co pilot who has the password), or by a ground controller in case of emergency. Then a hijacking could not take control of the aircraft. “911 Autopilot” is a low cost variation, which simply delays disengagement of autopilot until a military escort arrives. The military escort could remotely control the release of the autopilot or a simple time delay could release autopilot. In either case, the hijacked plane would be under military escort and therefore it would be unable to be used to ram buildings.

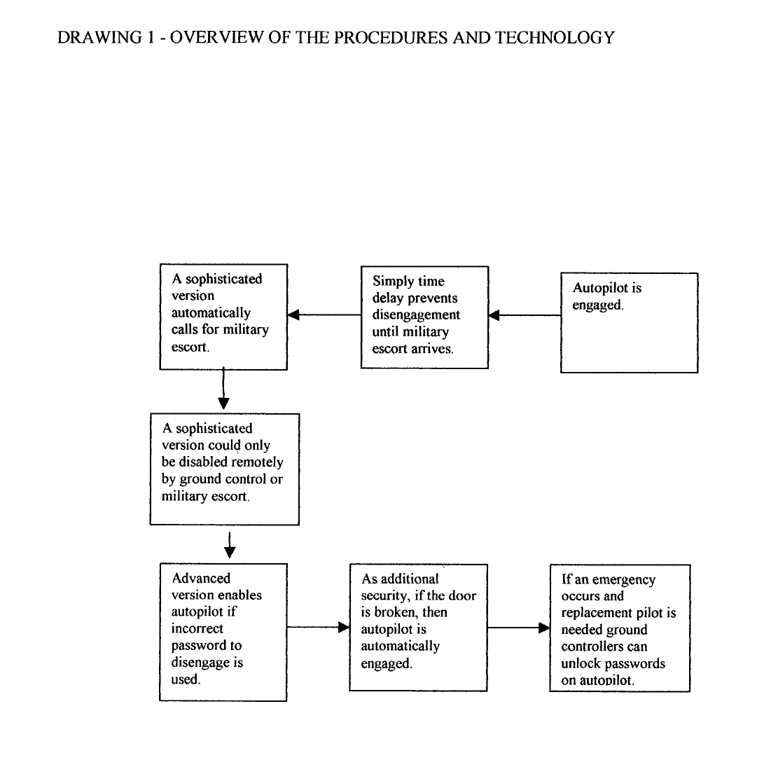

### BACKGROUND OF THE INVENTION

Given the tragedy of the four hijacked U.S. aircraft on Sep. 11, 2001, it is imperative that cost-effective, easy to implement technology and procedures be developed to prevent these hijackings in the future. The current methods or procedures are too costly, complicated or cumbersome and have not proved effective. The procedures and invention by Mark R. Haley, complement existing technology, yet elegantly and effectively will eliminate hijacking. If followed as outlined, then it would not matter if heavily armed hijackers took over the plane, as long as these procedures were followed, the hijacking would be effectively foiled. Today's protection depends on elaborate ground screenings of passengers and luggage, which can fail if even a razor blade passes detection, in fact the hijackers on September 11^{th} may have only had razor blades. They used these to overpower the pilots and take control and ram the planes into targets on the ground including the United States Pentagon. While elaborate security procedures on the ground and in the air have been implemented, the hijacking of four planes in one day shows that the current procedures and technology is totally ineffective against well-planned hijackings.

Mr. Haley's technology and procedures, is cost effective and complements existing technology so it can be implemented quickly, inexpensively and effectively.

### BRIEF SUMMARY OF THE INVENTION

As noted above, this invention provides a unique state-of-the-art procedure and technology to prevent hijacking of aircraft. The procedures include (1) using autopilot which cannot be disengaged with password from the pilot or ground control and (2) securing doors to the cockpit, which cannot be opened unless autopilot is engaged. This combination of technologies and procedures would eliminate the ability of hijackers to take control of the plane without active support of the pilots. “911 Autopilot” is an easier to implement since it simply calls for military escort and delays autopilot disengagement until help arrives.

### BRIEF DESCRIPTION OF THE SEVERAL VIEWS OF THE DRAWINGS

There is only one simple drawing, which is a flow chart of the logic in this invention. Several views are not on this flow chart. This flow chart (or drawing) simply shows the procedures and technology for preventing hijacking of airlines.

### DETAILED DESCRIPTION OF THE INVENTION

While elaborate security procedures exist to protect airlines from hijacking, the tragic simultaneous seizure of four U.S. aircraft on Sep. 11, 2001 illustrates that the current technology is not effective. Moreover, any alternative technology has proven to costly or cumbersome to implement. In short, the state-of-the-art today is cumbersome, costly and simply is not working. The invention by Mark R. Haley is unique because it overcomes these limitations. Moreover, as noted above, this invention will complement existing technology so it can be implemented quickly and inexpensively.

There are three parts to this invention:

Part One—The pilot cannot open the door to leave the cockpit without engaging a password-protected autopilot. To prevent breakdown of the door when the autopilot is engaged, then the cockpit doors should be strengthened. But even then, if the door is broken, this should automatically engage the password-protected autopilot. The autopilot options should be enhanced from take-off to landing so that the pilot would initiate take-off with autopilot engaged thereby foiling hijacking from take-off to landing.

Part Two—The password-protected autopilot could only be disengaged by the pilot (or copilot who has the password). However, to prevent emergencies in which the pilots are disabled, then a ground controller could override the password-protected autopilot and permit manual controls to resume.

Part Three—Even if a hijacking was successful and the pilots were removed, the hijackers could not control the plane without help from the pilots. And it is generally assumed the most pilots, unless they are cohorts of the hijackers would not fly their planes as missiles as those used in on Sep. 11, 2001. In short, the options for hijackers would be severely limited if this inexpensive, easy-to-implement technology and procedures were implemented.

Less Expensive Variations—A simple but even more cost effective option would be simply to have a time delay of autopilot on a “panic button”. The pilot or even a designated flight attendant would have access to a panic button to engage the autopilot for a short period—15 to 30 minutes. This would also signal a distress signal, which would notify ground controllers or NORAD so that jets could be scrambled for a military escort. If it were a hijacking—or if the pilot had been part of a hijacking—this inexpensive method would stop the hijacking. Since either the pilots or a designated flight attendant could initiate this short-term 15-30 minute autopilot, then a hijacking would never succeed. Once the military escort arrived, then the hijackers would have a choice—comply or the military jets would take appropriate response. This option would be very inexpensive and could be quickly implemented. Of course, a more sophisticated “911 autopilot” would be desirable since autopilot could be engaged until a safe landing. The inexpensive option might require a very difficult decision—abort the hijacking by shooting down the plane. But hijackers could never again use the plane as a missile for attacking the ground. So the inexpensive option of “911 autopilot” would force—the hijackers to choose—comply with the military jets or have the plane shot down in flight. A sophisticated “911 autopilot” would be the best option—but in the short term and until the technology is available, a simpler option with just a panic button and a 15 to 30 minute engaged autopilot might be the only option

Mark R. Haley has created procedures and technology, which would effectively preventing hijacking of aircraft.

What I, Mark R. Haley, claim as my invention is:

1) Claim one is a unique combination of technology and procedures, which would foil hijackings. The autopilot on aircraft would be password protected and could be engaged from take-off through landing. The pilot could not open the cockpit door without the autopilot engaged (it would automatically engage if he opened the door). And if the door were forcibly opened the autopilot would be engaged. This would eliminate control of hijacker who overpowered the pilot. A ground controller could override the password protection, but this would only done for legitimate emergencies. Using voice recognition, fingerprint or retina or any other system of identifying the pilot or the copilot, could enhance the system. These more advanced systems of protecting the disengaging of autopilot would further reduce the chance of hijacking. If the system required two forms of consent, i.e. both pilots, then this would ensure that a single deranged pilot could not even hijack the plane. And the system could be overridden by ground control in a genuine emergency. As an enhancement, remote control of the autopilot could be taken over by ground controllers if suspicious activity occurred such as the cockpit down being broken, or an emergency signal by the pilot. “911 Autopilot” offers a low cost version, which simply is a time, delayed before autopilot is disengaged. This could include an automatic call for military escort, thereby insuring that an aircraft has a military escort before control is returned to hijackers. This technology would be very easy to quickly implement since it only involves a time delay of autopilot disengagement. So password protected autopilot with complete control from takeoff until landings would be the best system but in the interim, a low cost “911 Autopilot” may be the only short-term solution. Any variations of password protection, and time delay for disengagement, and remote control of autopilot are covered by this invention.
